(19) United States
(12) Patent Application Publication
(10) Pub. No.: US 2023/0249344 A1
(43) Pub. Date: Aug. 10, 2023

(54) ROBOT CONTROL DEVICE

(71) Applicant: FANUC CORPORATION, Minamitsuru-gun, Yamanashi (JP)

(72) Inventor: Yasuhiro NAITOU, Yamanashi (JP)

(21) Appl. No.: 18/010,571

(22) PCT Filed: Jul. 1, 2021
(86) PCT No.: PCT/JP2021/024934

§ 371 Date: Dec. 15, 2022

(30) Foreign Application Priority Data
Jul. 8, 2020 (JP) 2020-117899

(51) Int. Cl. B25J 9/16; B25J 13/08

(52) U.S. Cl. CPC B25J 9/1633; B25J 9/1689; B25J 13/085

(57) ABSTRACT

In the present invention, a tool tip point can be easily and intuitively defined without having to operate a robot. This robot control device comprises an acquisition unit for acquiring force data indicating an external force applied to a tool mounted to a robot as sensed by a sensor equipped to the robot, a point-of-action calculation unit for calculating the point of action of the external force on the basis of the force data as acquired by the acquisition unit, and a configuration unit for defining the point of action of the external force as a tool tip point of the robot.

### TECHNICAL FIELD

The present invention relates to a robot control device.

### BACKGROUND ART

As a method of setting a tool tip point of a robot, such a method is known whereby a robot operates and is taught by allowing a tool tip point to contact a jig or the like at a plurality of postures, and whereby the tool tip point is calculated from articular angles at the plurality of postures. For example, see Patent Document 1.

Patent Document 1: Japanese Unexamined Patent Application, Publication No. H8-085083

### DISCLOSURE OF THE INVENTION

### Problems to be Solved by the Invention

However, to calculate a tool tip point, it is necessary to cause a robot to operate to cause a tool tip point to contact a jig or the like requiring time and skill. Furthermore, the setting accuracy of a tool tip point and the period of time required for the setting work are determined depending on the degree of proficiency of an operator, resulting in such a case that the setting accuracy and the setting time required are not consistent.

Then, what is demanded is to easily and intuitively set a tool tip point without having to operate a robot.

### Means for Solving the Problems

A robot control device according to an aspect of the present disclosure includes: an acquisition unit configured to acquire force data indicating an external force applied to a tool attached to a robot as detected by a sensor disposed on the robot; a point-of-action calculation unit configured to calculate a point of action of the external force based on the force data as acquired by the acquisition unit; and a configuration unit configured to set the point of action of the external force as a tool tip point of the robot.

### Effects of the Invention

According to the aspect, it is possible to easily and intuitively set a tool tip point without having to operate a robot.

### BRIEF DESCRIPTION OF THE DRAWINGS

FIG. 1 is a functional block diagram illustrating a functional configuration example of a robot system according to a first embodiment;

FIG. 2 is a diagram illustrating an example of a robot;

FIG. 3 is a diagram illustrating an example when a user has applied a force at a tip of a tool in another direction;

FIG. 4 is a flowchart illustrating calculation processing performed by a robot control device;

FIG. 5 is a functional block diagram illustrating a functional configuration example of a robot system according to a second embodiment;

FIG. 6 is a diagram illustrating an example of a robot;

FIG. 7 is a diagram illustrating an example of offset between centers of rotation of articulated shafts;

FIG. 8 is a diagram illustrating an example when a user has applied a force at a tip of a tool in one of horizontal directions;

FIG. 9 is a flowchart illustrating calculation processing performed by a robot control device;

FIG. 10 is a functional block diagram illustrating a functional configuration example of a robot system according to a third embodiment;

FIG. 11 is a diagram illustrating an example of a chuck;

FIG. 12 is a flowchart illustrating calculation processing performed by a robot control device;

FIG. 13 is a diagram illustrating an example of a chuck; and

FIG. 14 is a diagram illustrating an example when a user U has designated a desired position on a straight line connecting two points of action.

### PREFERRED MODE FOR CARRYING OUT THE INVENTION

A first embodiment will now be described herein with reference to the accompanying drawings.

### First Embodiment

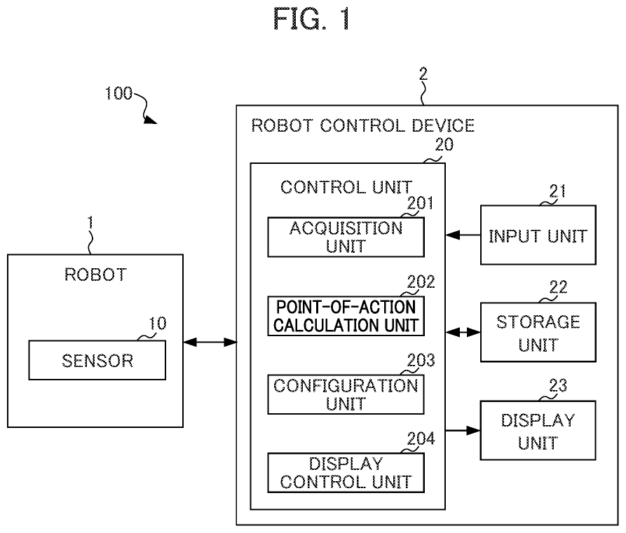

FIG. 1 is a functional block diagram illustrating a functional configuration example of a robot system according to the first embodiment.

As illustrated in FIG. 1, a robot system 100 includes a robot 1 and a robot control device 2.

The robot 1 and the robot control device 2 may be directly coupled to each other via a coupling interface (not shown). Note that the robot 1 and the robot control device 2 may be coupled to each other via a network such as a local area network (LAN). In this case, the robot 1 and the robot control device 2 may each include a communication unit (not shown) for performing intercommunications through the coupling.

### Robot 1

The robot 1 is, for example, an industry robot known among those skilled in the art.

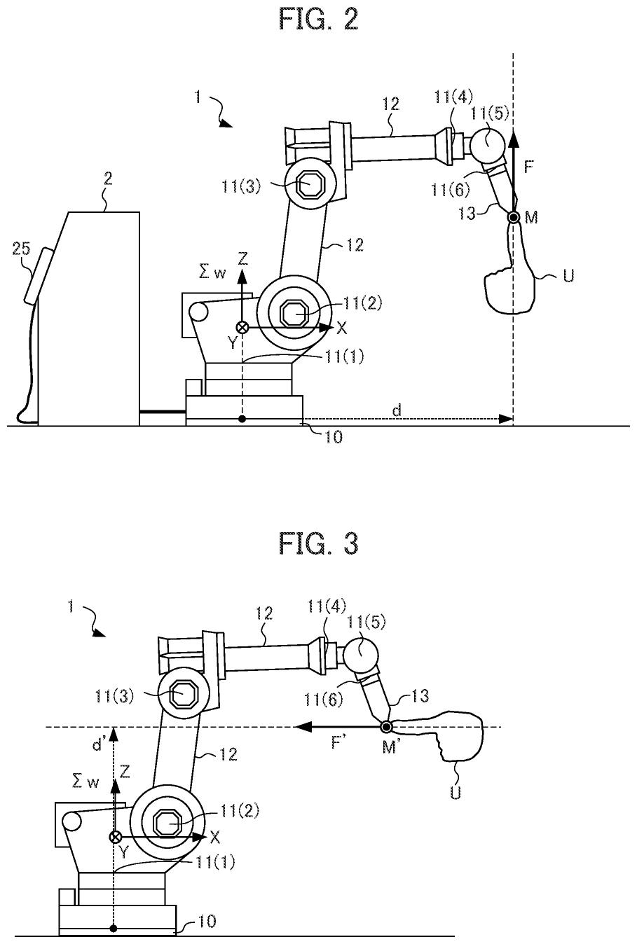

FIG. 2 is a diagram illustrating an example of the robot 1.

The robot 1 is, for example, as illustrated in FIG. 2, a six-axis vertical multi-articulated robot having six articulated shafts 11(1) to 11(6) and arm parts 12 coupled to each other by the articulated shafts 11(1) to 11(6). The robot 1 drives, based on a drive command provided from the robot control device 2, servo motors (not shown) respectively disposed on the articulated shafts 11(1) to 11(6) to drive moving members including the arm parts 12. Furthermore, a tool 13 such as a grinder or a screwdriver is attached to a tip part of a manipulator of the robot 1, such as a tip part of the articulated shaft 11(6).

Furthermore, in FIG. 2, a six-axis force sensor is disposed on a base of the robot 1 as a sensor 10. Thereby, the sensor 10 is configured to periodically detect at a predetermined sampling time a force F (=(Fₓ, F_{y}, F_{z})) and torque M (=(Mₓ, M_{y}, M_{z})), as a pressing force to the tool 13. Furthermore, the sensor 10 detects, also in a case when a user U applies a force to the tool 13, the force F and the torque M of the force applied by the user U. The sensor 10 outputs, via the coupling interface (not shown), force data pertaining to the detection to the robot control device 2.

Note that, although the robot 1 has been described as a six-axis vertical multi-articulated robot, it may be another vertical multi-articulated robot than the six-axis vertical multi-articulated robot, such as a horizontal multi-articulated robot or a parallel link robot.

Furthermore, when it is not necessary to separately describe the articulated shafts 11(1) to 11(6) from each other, they will be hereinafter collectively referred to as “articulated shafts 11”.

Furthermore, the robot 1 has a world coordinate system Σw that is a three-dimensional orthogonal coordinate system fixed in a space and a mechanical interface coordinate system for three-dimensional orthogonal coordinates that are set at a flange of a tip of the articulated shaft 11(6) of the robot 1. In the present embodiment, with a known calibration, the world coordinate system Σw and the mechanical interface coordinate system have been correlated to each other in position in advance. Thereby, the robot control device 2 described later is able to use positions defined in the world coordinate system Σw to control the position of a tip part of the robot 1, at which the tool 13 described later is attached.

### Robot Control Device 2

The robot control device 2 is configured to output, as illustrated in FIGS. 1 and 2, based on a program, a drive command to the robot 1 to control operation of the robot 1. Note that, in FIG. 2, a teaching operation panel 25 configured to teach the robot 1 its operation is coupled to the robot control device 2.

As illustrated in FIG. 1, the robot control device 2 according to the present embodiment includes a control unit 20, an input unit 21, a storage unit 22, and a display unit 23. Furthermore, the control unit 20 includes an acquisition unit 201, a point-of-action calculation unit 202, a configuration unit 203, and a display control unit 204.

The input unit 21 includes, for example, a keyboard and buttons (not shown) included in the robot control device 2 and a touch panel of the display unit 23 described later, and is configured to accept an operation from the user U of the robot control device 2.

The storage unit 22 includes, for example, a read only memory (ROM) and a hard disk drive (HDD), and is configured to store system programs and application programs, for example, that the control unit 20 described later executes. Furthermore, the storage unit 22 may store a point of action calculated by the point-of-action calculation unit 202 described later.

The display unit 23 is a display device such as a liquid crystal display (LCD) configured to display, based on a control command provided from the display control unit 204 described later, a message providing an instruction to the user U and a screen indicating a positional relationship between a point of action calculated by the point-of-action calculation unit 202 described later and the robot 1, for example.

### Control Unit 20

The control unit 20 is one that is known among those skilled in the art, and that includes a central processing unit (CPU), read-only memory (ROM), random access memory (RAM), and complementary metal-oxide-semiconductor (CMOS) memory, for example, which are configured to communicate with each other via a bus.

The CPU represents a processor that wholly controls the robot control device 2. The CPU is configured to read, via the bus, the system programs and the application programs stored in the ROM, to wholly control the robot control device 2 in accordance with the system programs and the application programs. Thereby, as illustrated in FIG. 1, the control unit 20 is configured to achieve functions of the acquisition unit 201, the point-of-action calculation unit 202, the configuration unit 203, and the display control unit 204. The RAM is configured to store various types of data including temporal calculation data and display data. Furthermore, the CMOS memory is backed up by a battery (not shown), and is thus configured as a non-volatile memory configured to hold a stored state even when a power supply to the robot control device 2 goes off.

The acquisition unit 201 is configured to acquire, for example, as illustrated in FIG. 2, as the user U applies a force to the tool 13, force data indicating the external force that is applied to the tool 13 and that is detected by the sensor 10.

Specifically, the acquisition unit 201 acquires force data of a force vector and a torque vector of the external force that is applied to the tool 13 and that is detected by the sensor 10.

The point-of-action calculation unit 202 is configured to calculate, based on the force data acquired by the acquisition unit 201, a point of action of the external force, which represents the position at which the user U has applied the force to the tool 13.

Note herein that, for example, as illustrated in FIG. 2, in a case where, as the user U applies a force at a tip of the tool 13 in a Z-axis direction, for a vector of the force F and the torque M acquired by the acquisition unit 201, with a positional vector d (=(dₓ, d_{y}, d_{z})) heading from the sensor 10 toward a closest point to a straight line passing through a point of action, M=d×F (“×” indicates a cross product) is satisfied due to a balanced moment of force known among those skilled in the art. Note that a black dot on the sensor 10 in FIG. 2 indicates a starting point of the positional vector d. The point-of-action calculation unit 202 assigns values of the vector of the force F and the torque M acquired by the acquisition unit 201 into M=d×F to solve three simultaneous equations for unknown numbers (dₓ, d_{y}, d_{z}) to calculate the positional vector d heading toward the closest point to the straight line passing through the point of action.

Thereby, the point-of-action calculation unit 202 is able to acquire a straight line (a broken line in FIG. 2) that starts from a point of detection by the sensor 10, passes through the positional vector d, and extends in a direction of a vector F (=(Fₓ, F_{y}, F_{z})), on which a tool tip point is present.

Note that, although, in FIG. 2, the user U has applied a force to the tip of the tool 13 in the Z-axis direction, a force may be applied at a desired position on the tool 13 in a desired direction.

Next, to acquire a tool tip point, the point-of-action calculation unit 202 causes, for example, the display control unit 204 described later to cause the display unit 23 to display a message such as “Press it in another direction” to instruct the user U to apply a force to the tip of the tool 13 in another direction.

FIG. 3 is a diagram illustrating an example when the user U has applied a force to the tip of the tool 13 in another direction.

As illustrated in FIG. 3, for example, as the user U applies a force to the tip of the tool 13 in a direction (e.g., one of horizontal directions (an −X-axis direction)) that differs from that in the case illustrated in FIG. 2, the point-of-action calculation unit 202 assigns values of a vector of a force F′ and torque M′ acquired by the acquisition unit 201 into M=d×F. The point-of-action calculation unit 202 solves three simultaneous equations of unknown numbers (d′ₓ, d′_{y}, d′_{z}) to calculate a positional vector d′ heading toward a closest point to a straight line passing through a point of action.

Then, the point-of-action calculation unit 202 acquires, as a point of action, an intersection between the straight line (the broken line in FIG. 2) that passes through the positional vector d and extends in a direction of the vector F and a straight line (a broken line in FIG. 3) that passes through the positional vector d′ and extends in a direction of the vector F′.

As described above, as the user U applies forces to the tool 13 in two directions that differ from each other, the point-of-action calculation unit 202 is able to accurately calculate a point of action (an intersection).

Note that, when it is not possible to acquire an intersection between two straight lines due to an error in detection by the sensor 10 and/or an error in position of the tip of the tool 13 at which the user U applies forces, the point-of-action calculation unit 202 may acquire closest points to two straight lines and may regard a midpoint between the acquired closest points as a point of action.

Furthermore, although the user U has applied forces to the tip of the tool 13 in two directions that differ from each other, forces may be applied to the tip of the tool 13 in three or more directions that differ from each other.

The configuration unit 203 is configured to set the point of action calculated by the point-of-action calculation unit 202 as a tool tip point of the tool 13 of the robot 1.

The display control unit 204 is configured to cause, for example, the display unit 23 to display a message instructing the user U to press the tool 13 on the robot 1 to set a tool tip point and to cause the display unit 23 to display a screen indicating a positional relationship between a point of action calculated by the point-of-action calculation unit 202 and the robot 1.

### Calculation Processing Performed by Robot Control Device 2

Next, operation pertaining to calculation processing performed by the robot control device 2 according to the present embodiment will be described herein.

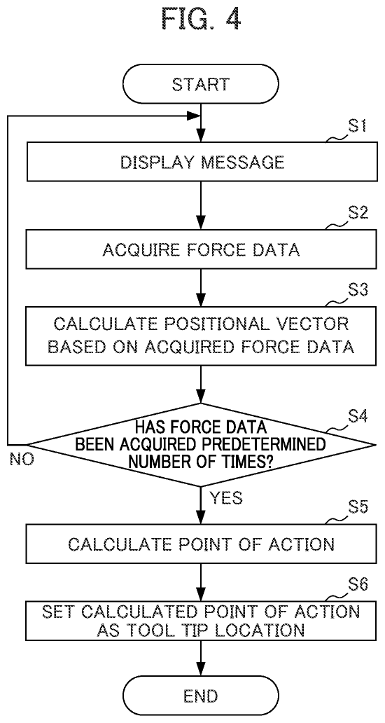

FIG. 4 is a flowchart illustrating the calculation processing performed by the robot control device 2. The flow illustrated herein is executed each time a command for setting a tool tip point is received from the user U via the input unit 21.

At Step S1, the display control unit 204 causes the display unit 23 to display a message instructing the user U to apply a force to the tool 13, such as “Press tool tip”.

At Step S2, as the user U applies a force to the tool 13, the acquisition unit 201 acquires force data of the force F and the torque M of the external force that is applied to the tool 13 and that is detected by the sensor 10.

At Step S3, the point-of-action calculation unit 202 calculates, based on the force data acquired at Step S2, the positional vector d heading toward a closest point to a straight line passing through a point of action on the tool 13.

At Step S4, the point-of-action calculation unit 202 determines whether force data has been acquired a predetermined number of times (e.g., twice). When force data has been acquired the predetermined number of times, the processing proceeds to Step S5. On the other hand, when force data has not yet been acquired the predetermined number of times, the processing returns to Step S1. Note that, in this case, at Step S1, it is preferable that the display control unit 204 causes the display unit 23 to display a message such as “Press tool tip in another direction”.

At Step S5, the point-of-action calculation unit 202 calculates, based on the detected vectors F, F′ and the calculated positional vectors d, d′, an intersection of the two straight lines as a point of action.

At Step S6, the configuration unit 203 sets the point of action calculated at Step S5 as a tool tip point of the tool 13 on the robot 1.

As described above, the robot control device 2 according to the first embodiment acquires an external force applied by the user U to the tool 13 attached to the robot 1 as force data of the force F and the torque M detected by the sensor 10 disposed on the robot 1. The robot control device 2 calculates, based on the acquired force data, a point of action of the external force and sets the point of action as a tool tip point of the robot 1. Thereby, the robot control device 2 makes it possible to easily and intuitively set a tool tip point without having to operate the robot 1.

The first embodiment has been described above.

### Second Embodiment

Next, a second embodiment will be described herein.

Note herein that the robot control device 2 according to the first embodiment and a robot control device 2a according to the second embodiment are common in that a tool tip point is set based on force data detected as the user U applies a force to the tip of the tool 13.

However, in the first embodiment, force data is detected by using a six-axis force sensor. On the other hand, the second embodiment differs from the first embodiment in that force data is detected by using torque sensors respectively disposed on the articulated shafts 11 of the robot 1.

Thereby, the robot control device 2a according to the second embodiment makes it possible to easily and intuitively set a tool tip point without having to operate a robot 1a.

The second embodiment will now be described below.

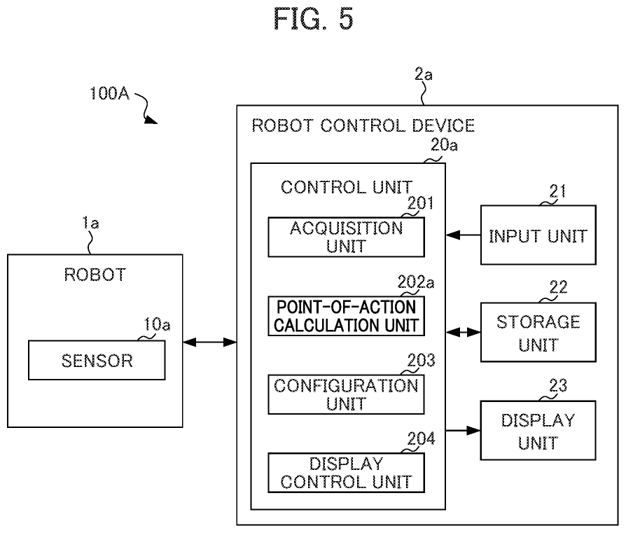

FIG. 5 is a functional block diagram illustrating a functional configuration example of a robot system according to the second embodiment. Note that, for those elements having functions similar to those of the elements of the robot system 100 in FIG. 1, identical reference symbols are attached, and detailed descriptions are omitted.

As illustrated in FIG. 5, a robot system 100A includes, similar to the first embodiment, the robot 1a and the robot control device 2a.

### Robot 1a

The robot 1a is, for example, similar to the case according to the first embodiment, an industry robot known among those skilled in the art.

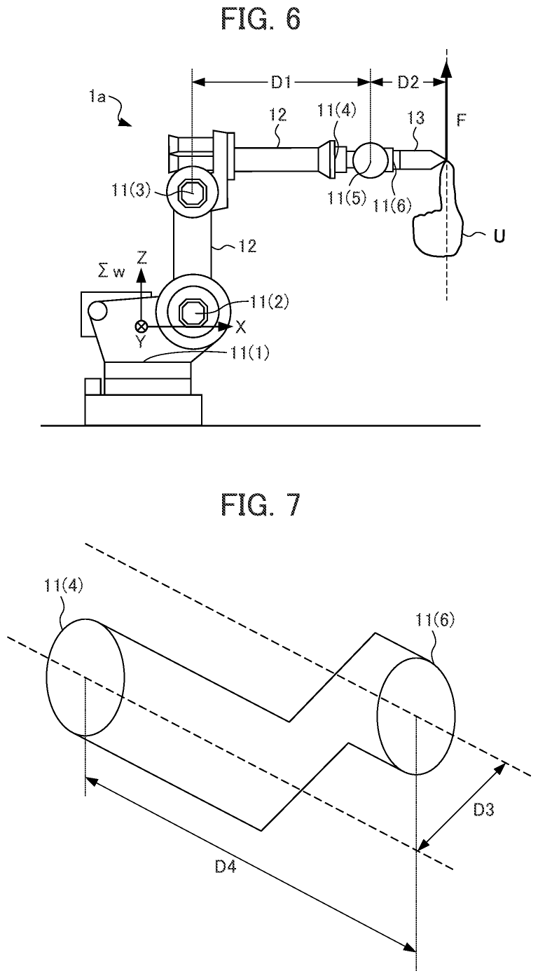

FIG. 6 is a diagram illustrating an example of the robot 1a.

The robot 1a is, for example, similar to the case according to the first embodiment, a six-axis vertical multi-articulated robot having six articulated shafts 11(1) to 11(6) and arm parts 12 coupled to each other by the articulated shafts 11(1) to 11(6). The robot 1a drives, based on a drive command provided from the robot control device 2a, servo motors (not shown) respectively disposed on the articulated shafts 11(1) to 11(6) to drive moving members including the arm parts 12. Furthermore, a tool 13 such as a grinder or a screwdriver is attached to a tip part of a manipulator of the robot 1a, such as a tip part of the articulated shaft 11(6).

Furthermore, sensors 10a (not shown) that are torque sensors each configured to detect torque about a rotation shaft are respectively disposed on the articulated shafts 11(1) to 11(6) of the robot 1a. Thereby, the sensors 10a on the articulated shafts 11 are each configured to periodically detect at a predetermined sampling time torque M, as a pressing force to the tool 13. Furthermore, the sensors 10a on the articulated shafts 11 each detect, also in a case when a user U applies a force to the tool 13, the torque M of the force applied by the user U. The sensors 10a on the articulated shafts 11 each output, via a coupling interface (not shown), force data pertaining to the detection to the robot control device 2a.

### Robot Control Device 2a

The robot control device 2a is configured to output, similar to the case according to the first embodiment, based on a program, a drive command to the robot 1a to control operation of the robot 1a.

As illustrated in FIG. 5, the robot control device 2a according to the second embodiment includes a control unit 20a, an input unit 21, a storage unit 22, and a display unit 23. Furthermore, the control unit 20a includes an acquisition unit 201, a point-of-action calculation unit 202a, a configuration unit 203, and a display control unit 204.

The control unit 20a, the input unit 21, the storage unit 22, and the display unit 23 respectively have functions equivalent to those of the control unit 20, the input unit 21, the storage unit 22, and the display unit 23 according to the first embodiment.

Furthermore, the acquisition unit 201, the configuration unit 203, and the display control unit 204 respectively have functions equivalent to those of the acquisition unit 201, the configuration unit 203, and the display control unit 204 according to the first embodiment.

The point-of-action calculation unit 202a is configured to use, for example, as illustrated in FIG. 6, as the user U applies a force at a desired point on the tool 13 (e.g., a tip of the tool 13) in the Z-axis direction, the torque M detected by each of the sensors 10a on the articulated shafts 11 to acquire a position of a point of action. Note that, in this case, centers of rotation of the articulated shaft 11(4) and the articulated shaft 11(6) are offset from each other.

FIG. 7 is a diagram illustrating an example of offset between the centers of rotation of the articulated shaft 11(4) and the articulated shaft 11(6). As illustrated in FIG. 7, the centers of rotation of the articulated shaft 11(4) and the articulated shaft 11(6) are offset from each other by a distance D3.

Note that, although, in FIG. 6, the user U has applied a force at a desired point on the tool 13 in the Z-axis direction, a force may be applied at a desired position on the tool 13 in a predetermined direction. For example, the display control unit 204 causes the display unit 23 to display a message such as “Press point you want to set in +Z-axis direction”.

Specifically, the point-of-action calculation unit 202a uses, for example, as the user U applies a force to the tip of the tool 13 in the Z-axis direction, values of torque M3, M5 detected by the sensor 10a on the articulated shaft 11(3) and the sensor 10a on the articulated shaft 11(5) and also uses Equation (1) to calculate a distance D2 from the articulated shaft 11(5) to a straight line passing through a point of action, which is illustrated by a broken line.

D2=(M5/(M3−M5))D1 (1)

Note that D1 represents a distance in a direction orthogonal to a directional vector acquired when a direction of a force between the articulated shaft 11(3) and the articulated shaft 11(5) is projected onto a plane of rotation of the articulated shaft, and is already known. When the direction of the force corresponds to the +Z-axis direction, it represents a horizontal distance (a distance in the X-axis direction) between the articulated shaft 11(3) and the articulated shaft 11(5). Furthermore, Equation (1) is calculated from a relationship between M3=(D1+D2)×F and M5=D2×F.

Furthermore, the point-of-action calculation unit 202a uses values of torque M4, M6 detected by the sensor 10a on the articulated shaft 11(4) and the sensor 10a on the articulated shaft 11(6) and also uses Equation (2) to calculate the distance D3 of offset, as illustrated in FIG. 7, which has appeared due to the user U applying force to the tip of the tool 13 (e.g., the force in the Z-axis direction).

D3=(M6/(M4−M6))D4 (2)

Note that D4 represents, as illustrated in FIG. 7, a horizontal distance (a distance in the X-axis direction) between the articulated shaft 11(4) and the articulated shaft 11(6).

Next, in order for the point-of-action calculation unit 202a to acquire a tool tip point, for example, the display control unit 204 causes the display unit 23 to display a message such as “Press the same point in −X-axis direction” to instruct the user U to apply a force to the tip of the tool 13 in another predetermined direction.

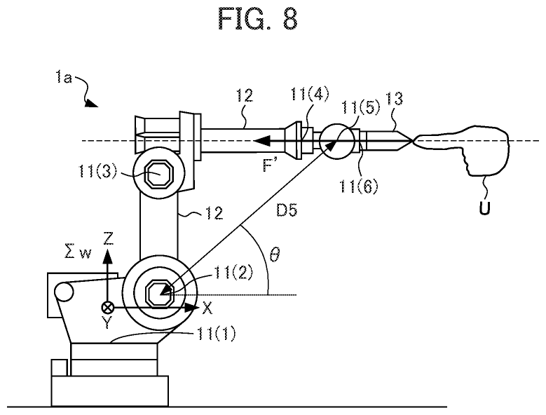

FIG. 8 is a diagram illustrating an example when the user U has applied a force to the tip of the tool 13 in one of the horizontal directions.

The point-of-action calculation unit 202a uses, similar to the case when the distances D2, D3 are calculated, values of torque M2′, M5′ detected by the sensors 10a on the articulated shaft 11(2) and the articulated shaft 11(5) when the user U has applied a force in one of the horizontal directions (in the −X-axis direction) to calculate a distance H to a straight line illustrated by a broken line (a position in a height direction (the Z-axis direction)) (=D5sinθ)).

Then, the point-of-action calculation unit 202a uses, together with the already known distance D1, the calculated distances D2, D3, and the height H to acquire two three-dimensional straight lines, i.e., a straight line extending in a direction of the force F at the distance D2 from the articulated shaft 11(5), which is illustrated by the broken line in FIG. 6, and a straight line extending in a direction of the force F′ at the height H, which is illustrated by a broken line in FIG. 8. The point-of-action calculation unit 202a is able to calculate an intersection between the acquired two three-dimensional straight lines as a point of action on the tool 13.

That is, as the user U applies forces to the tip of the tool 13 in two directions that differ from each other, the point-of-action calculation unit 202a is able to accurately calculate a point of action.

Note that, when it is not possible to acquire an intersection between two three-dimensional straight lines due to an error in detection by the sensors 10a and/or an error in position of the tip of the tool 13 at which the user U applies forces, the point-of-action calculation unit 202a may acquire closest points to two three-dimensional straight lines and may regard a midpoint between the acquired two three-dimensional straight lines as a point of action.

Furthermore, although the user U has applied forces to the tip of the tool 13 in two directions that differ from each other, forces may be applied to the tip of the tool 13 in three or more directions that differ from each other.

### Calculation Processing Performed by Robot Control Device 2a

Next, operation pertaining to calculation processing performed by the robot control device 2a according to the present embodiment will be described herein.

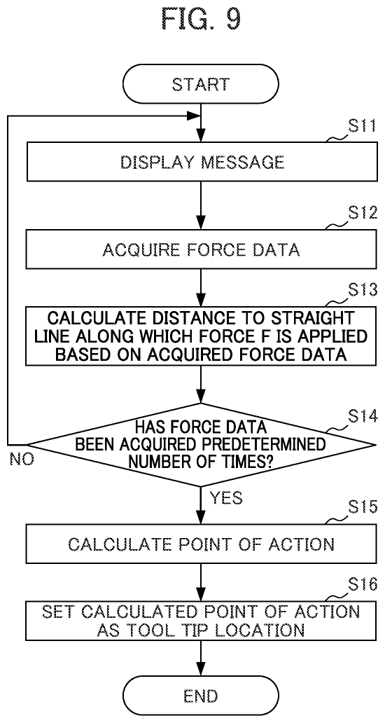

FIG. 9 is a flowchart illustrating the calculation processing performed by the robot control device 2a. The flow illustrated herein is executed each time a command for setting a tool tip point is received from the user U via the input unit 21.

Note that the processing at Steps S11, S12, and S16 illustrated in FIG. 9 are similar to those at Steps S1, S2, and S6 according to the first embodiment, and detailed descriptions are omitted.

At Step S13, the point-of-action calculation unit 202a calculates, based on the force data acquired at Step S12, a distance to a straight line extending in the direction in which the force F has been applied.

At Step S14, the point-of-action calculation unit 202a determines whether force data has been acquired a predetermined number of times (e.g., twice). When force data has been acquired the predetermined number of times, the processing proceeds to Step S15. On the other hand, when force data has not yet been acquired the predetermined number of times, the processing returns to Step S11. Note that, in this case, at Step S11, it is preferable that the display control unit 204 causes the display unit 23 to display a message such as “Press the same point on tool tip in −X-axis direction”.

At Step S15, the point-of-action calculation unit 202 acquires two three-dimensional straight lines based on the distances to the straight lines along which the forces F have been applied, which have been each calculated for the predetermined number of times, to calculate an intersection between the acquired two three-dimensional straight lines as a point of action.

As described above, the robot control device 2a according to the second embodiment acquires an external force applied by the user U to the tool 13 attached to the robot 1a as force data of the torque M detected by the sensor 10a disposed on each of the articulated shafts 11 of the robot 1a. The robot control device 2a calculates, based on the acquired force data, a point of action of the external force and sets the point of action as a tool tip point of the robot 1a. Thereby, the robot control device 2a makes it possible to easily and intuitively set a tool tip point without having to operate the robot 1a.

The second embodiment has been described above.

### Third Embodiment

Next, a third embodiment will be described herein.

Note herein that the robot control devices according to the embodiments are common in that a tool tip point is set based on force data detected as the user U applies a force to the tool 13.

However, the third embodiment differs from the first embodiment and the second embodiment in that in the third embodiment the user U is not able to directly apply a force to the tip of the tool 13, but forces are applied at any two locations on the tool 13, points of action respectively at the two locations are calculated, and a midpoint on a straight line connecting the calculated points of action respectively at the two locations is set as a tool tip point.

Thereby, a robot control device 2b according to the third embodiment makes it possible to easily and intuitively set a tool tip point without having to operate a robot 1.

The third embodiment will now be described below.

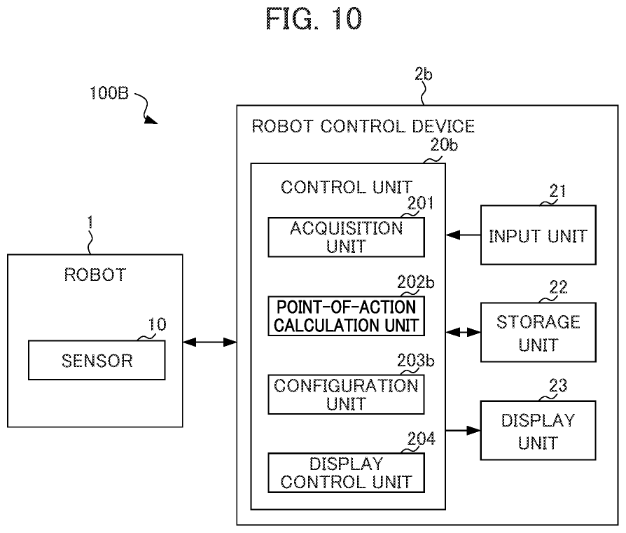

FIG. 10 is a functional block diagram illustrating a functional configuration example of a robot system according to the third embodiment. Note that, for those elements having functions similar to those of the elements of the robot system 100 in FIG. 1, identical reference symbols are attached, and detailed descriptions are omitted.

As illustrated in FIG. 10, a robot system 100B includes, similar to the first embodiment, the robot 1 and the robot control device 2b.

### Robot 1

The robot 1 includes at its base, similar to the case according to the first embodiment illustrated in FIG. 2, a sensor 10 that is a six-axis force sensor. Note that the robot 1 according to the third embodiment is attached with, as a tool 13, for example, a chuck having two claws for holding a tool.

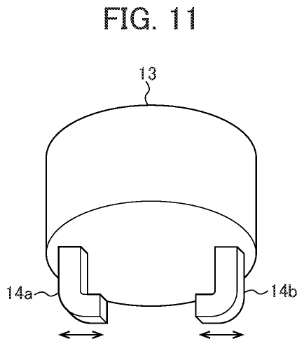

FIG. 11 is a diagram illustrating an example of the chuck.

As illustrated in FIG. 11, the chuck that is the tool 13 has two claws 14a, 14b. As the two claws 14a, 14b move in directions illustrated by arrows based on an operation command provided from the robot control device 2b, an object such as a tool is held. In this case, since a tool tip point of the tool 13 lies at a position between the two claws 14a, 14b, i.e., lies at a suspended position, a user U is not able to directly apply a force at the position.

Then, the robot control device 2b described later allows the user U to apply forces respectively to the two claws 14a, 14b of the chuck that is the tool 13, calculates points of action on the claws 14a, 14b, and sets a midpoint on a straight line connecting the calculated two points of action as a tool tip point.

Note that, although, in the third embodiment, the robot 1 including the sensor 10 that is a six-axis force sensor has been used, the robot 1a including the sensors 10a that are torque sensors respectively attached to the articulated shafts 11 may be used.

### Robot Control Device 2b

The robot control device 2b is configured to output, similar to the case according to the first embodiment, based on a program, a drive command to the robot 1 to control operation of the robot 1.

As illustrated in FIG. 10, the robot control device 2b according to the third embodiment includes a control unit 20b, an input unit 21, a storage unit 22, and a display unit 23. Furthermore, the control unit 20b includes an acquisition unit 201, a point-of-action calculation unit 202b, a configuration unit 203b, and a display control unit 204.

The control unit 20b, the input unit 21, the storage unit 22, and the display unit 23 respectively have functions equivalent to those of the control unit 20, the input unit 21, the storage unit 22, and the display unit 23 according to the first embodiment.

Furthermore, the acquisition unit 201, and the display control unit 204 respectively have functions equivalent to those of the acquisition unit 201 and the display control unit 204 according to the first embodiment.

The point-of-action calculation unit 202b is configured to calculate, similar to the point-of-action calculation unit 202 according to the first embodiment, based on force data acquired by the acquisition unit 201, a point of action of an external force, which represents a position at which the user U has applied the force to the tool 13.

Specifically, the point-of-action calculation unit 202b assigns, for example, as the user U applies a force to the claw 14a of the tool 13 that is the chuck, values of a vector of a force F and torque M detected by the sensor 10 into M=d×F to calculate a positional vector d heading toward a closest point to a straight line passing through a point of action on the claw 14a. Furthermore, the point-of-action calculation unit 202b assigns, as the user U applies a force to the claw 14a in another direction, values of a vector of a force F′ and torque M′ detected by the sensor 10 into M′=d′×F′ to calculate a positional vector d′ heading toward a closest point to a straight line passing through a point of action on the claw 14a. Then, the point-of-action calculation unit 202b acquires an intersection between a straight line passing through the positional vector d and extending in the direction of the vector F and a straight line passing through the positional vector d′ and extending in the direction of the vector F′ as a point of action on the claw 14a. The point-of-action calculation unit 202b causes the storage unit 22 to store the acquired point of action on the claw 14a.

Next, the point-of-action calculation unit 202b assigns, as the user U applies a force to the claw 14b of the tool 13 that is the chuck, values of a vector of the force F and the torque M detected by the sensor 10 into M=d×F to calculate the positional vector d heading toward a closest point to a straight line passing through a point of action on the claw 14b. Furthermore, the point-of-action calculation unit 202b assigns, as the user U applies a force to the claw 14b in another direction, values of a vector of the force F′ and the torque M′ detected by the sensor 10 to M′=d′×F′ to calculate the positional vector d′ heading toward a closest point to a straight line passing through a point of action on the claw 14b. Then, the point-of-action calculation unit 202b acquires an intersection between the straight line, which has passed through the positional vector d, extending in the direction of the vector F and the straight line, which has passed through the positional vector d′, extending in the direction of the vector F′ as a point of action on the claw 14b. The point-of-action calculation unit 202b causes the storage unit 22 to store the acquired point of action on the claw 14b.

The configuration unit 203b is configured to read the points of action on the two claws 14a, 14b, which are stored in the storage unit 22, and to set a midpoint on a straight line connecting the read two points of action as a tool tip point.

### Calculation Processing Performed by Robot Control Device 2b

Next, operation pertaining to calculation processing performed by the robot control device 2b according to the present embodiment will be described herein.

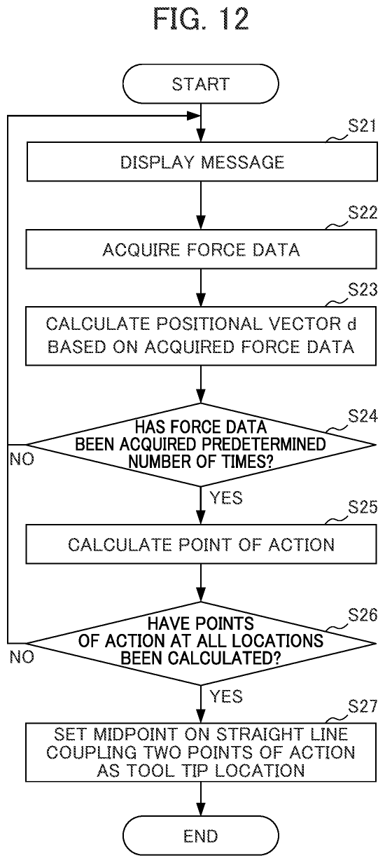

FIG. 12 is a flowchart illustrating the calculation processing performed by the robot control device 2b. The flow illustrated herein is executed each time a command for setting a tool tip point is received from the user U via the input unit 21.

At Step S21, the display control unit 204 causes the display unit 23 to display a message instructing the user U to apply a force to one of the claws 14a, 14b of the tool 13, such as “Press tool at one location”.

At Step S22, as the user U applies a force to the claw 14a of the tool 13, the acquisition unit 201 acquires force data of the force F and the torque M of the external force that is applied to the claw 14a and that is detected by the sensor 10.

At Step S23, the point-of-action calculation unit 202b calculates, based on the force data acquired at Step S22, the positional vector d heading toward a closest point to a straight line passing through a point of action on the claw 14a.

At Step S24, the point-of-action calculation unit 202b determines whether force data has been acquired a predetermined number of times (e.g., twice) for the one location. When force data has been acquired the predetermined number of times, the processing proceeds to Step S25. On the other hand, when force data has not yet been acquired the predetermined number of times, the processing returns to Step S21. Note that, in this case, at Step S21, it is preferable that the display control unit 204 causes the display unit 23 to display a message such as “Press the same location in another direction”.

At Step S25, the point-of-action calculation unit 202b calculates, based on the detected vectors F, F′ and the calculated positional vectors d, d′, an intersection between the two straight lines as a point of action.

At Step S26, the point-of-action calculation unit 202b determines whether points of action have been calculated for all locations (e.g., the two claws 14a, 14b) on the tool 13. When points of action have been calculated for all the locations, the processing proceeds to Step S27. On the other hand, when points of action have not yet been calculated for all the locations, the processing returns to Step S21. Note that, in this case, at Step S21, it is preferable that the display control unit 204 causes the display unit 23 to display a message such as “Press another location”.

At Step S27, the configuration unit 203b reads the points of action on the two claws 14a, 14b, which are stored in the storage unit 22, and sets a midpoint on a straight line connecting the read two points of action as a tool tip point.

As described above, the robot control device 2b according to the third embodiment acquires an external force applied by the user U to each of the two claws 14a, 14b of the tool 13 attached to the robot 1 as force data of the force F and the torque M detected by the sensor 10 disposed on the robot 1. The robot control device 2b calculates, based on the acquired force data, a point of action on each of the claws 14a, 14b of the tool 13 and sets a midpoint on a straight line connecting the points of action on the two claws 14a, 14b as a tool tip point of the robot 1. Thereby, the robot control device 2b makes it possible to easily and intuitively set a tool tip point without having to operate the robot 1.

The third embodiment has been described above.

### Modification Example 1 to Third Embodiment

In the third embodiment, although the tool 13 that is the chuck has the two claws 14a, 14b, there is no intention to limit to this configuration. For example, the tool 13 may be a chuck having three or more claws as a plurality of claws.

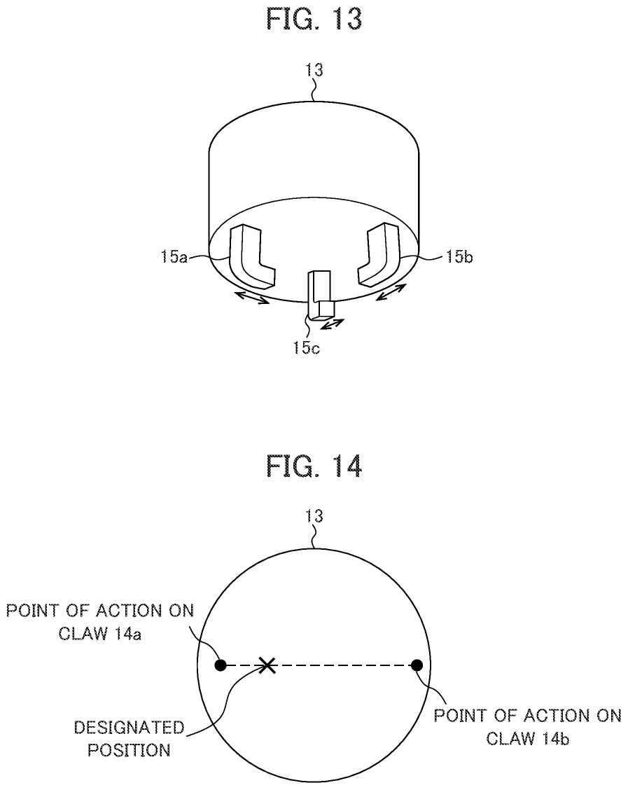

FIG. 13 is a diagram illustrating an example of a chuck.

As illustrated in FIG. 13, the chuck that is the tool 13 has three claws 15a, 15b, 15c. As the three claws 15a, 15b, 15c move in directions illustrated by arrows based on an operation command provided from the robot control device 2b, an object such as a tool is held.

In this case, the point-of-action calculation unit 202b may allow the user U to apply a force to each of the plurality of claws of the chuck that is the tool 13 to calculate a point of action on each of the plurality of claws. The configuration unit 203b may set a midpoint in a three or more sided polygonal shape formed by connecting the calculated points of action on the plurality of claws as a tool tip point of the robot 1.

### Modification Example 2 to Third Embodiment

In the third embodiment, although the configuration unit 203b has set a midpoint on a straight line connecting the points of action on the two claws 14a, 14b of the chuck that is the tool 13 as a tool tip point of the robot 1, there is no intention to limit to this configuration. For example, the display control unit 204 may cause the display unit 23 to display a screen indicating a positional relationship between a straight line connecting the points of action on the two claws 14a, 14b and the robot 1 to cause the configuration unit 203b to set a desired position on the straight line, which is designated based on an input by the user U via the input unit 21, as a tool tip point of the robot 1.

FIG. 14 is a diagram illustrating an example when the user U has designated a desired position on a straight line connecting two points of action. In FIG. 14, the position designated by the user U is illustrated on the straight line connecting the points of action, which are indicated by circles, on the two claws 14a, 14b.

Note that, even in a case where the chuck that is the tool 13 has a plurality of claws, the display control unit 204 may cause the display unit 23 to display a screen indicating a positional relationship between a polygonal shape formed by connecting the points of action on the plurality of claws and the robot 1 to cause the configuration unit 203b to set a desired position in the polygonal shape, which is designated based on an input by the user U via the input unit 21, as a tool tip point of the robot 1.

Although the first embodiment, the second embodiment, the third embodiment, Modification example 1 to the third embodiment, and Modification example 2 to the third embodiment have been described above, the robot control devices 2, 2a, 2b are not limited to those according to the embodiments described above, but include modifications and improvements that fall within the scope of the present invention, as long as it is possible to achieve the object of the present invention.

### MODIFICATION EXAMPLE 1

In the first embodiment, the second embodiment, the third embodiment, Modification example 1 to the third embodiment, and Modification example 2 to the third embodiment, there have been described the cases of the postures illustrated in FIGS. 2 and 6 as the postures of the robots 1, 1a when the user U applies a force. However, there is no intention to limit to these configurations. For example, the robots 1, 1a are able to each take a desired posture.

### MODIFICATION EXAMPLE 2

Furthermore, for example, in the first embodiment, the second embodiment, the third embodiment, Modification example 1 to the third embodiment, and Modification example 2 to the third embodiment described above, there have been two directions, i.e., the Z-axis direction and one of the horizontal directions (e.g., the −X-axis direction), as directions in which the user U applies forces. However, there is no intention to limit to these configurations. For example, directions in which the user U applies forces may be in any two directions as long as the directions differ from each other.

### MODIFICATION EXAMPLE 3

Furthermore, for example, in Modification example 2 to the third embodiment, a desired point on a straight line connecting two points of action has been set as a tool tip point. However, there is no intention to limit to this configuration. For example, the user U may be able to perform pressing only once. A straight line extending in a direction of the external force, which passes through a point of action, may be calculated. The display unit 23 may be caused to display a screen indicating a positional relationship between the calculated straight line and each of the robots 1, 1a. The configuration unit 203 may set a desired position on a straight line which is designated based on an input by the user U via the input unit 21, as a tool tip point of each of the robots 1, 1a.

Note that it is possible to achieve each of the functions included in the robot control devices 2, 2a, 2b according to the first embodiment, the second embodiment, the third embodiment, Modification example 1 to the third embodiment, and Modification example 2 to the third embodiment through hardware, software, or a combination thereof. Herein, achievement through software means achievement when a computer reads and executes programs.

Furthermore, it is possible to achieve the components included in the robot control devices 2, 2a, 2b through hardware including electronic circuits, software, or a combination thereof.

It is possible to use a non-transitory computer readable medium that varies in type to store the programs, and to supply the programs to a computer. Examples of the non-transitory computer readable medium include tangible storage media that vary in type. Examples of the non-transitory computer readable medium include magnetic recording media (e.g., flexible disks, electromagnetic tape, and hard disk drives), magneto-optical recording media (e.g., magneto-optical discs), compact disc read only memories (CD-ROMs), compact disc-recordables (CD-Rs), compact disc-rewritables (CD-R/Ws), and semiconductor memories (e.g., mask ROMs, programmable ROMs (PROMs), erasable PROMs (EPROMs), flash ROMs, and random access memories (RAMs)). Furthermore, the programs may be supplied to the computer via a transitory computer readable medium that varies in type. Examples of the transitory computer readable medium include electric signals, optical signals, and electromagnetic waves. A transitory computer readable medium is able to supply the programs to the computer via wired communication channels such as electric wires and optical fibers or wireless communication channels.

Note that steps for describing programs to be recorded in a recording medium include not only processes sequentially executed in a chronological order, but also processes that may not necessarily be executed in a chronological order, but may be executed in parallel or separately.

In other words, it is possible that the robot control devices according to the present disclosure take various types of embodiments having configurations described below.

(1) The robot control device 2 according to the present disclosure includes: the acquisition unit 201 configured to acquire force data indicating an external force applied to a tool attached to the robot 1 as detected by the sensor 10 disposed on the robot 1; the point-of-action calculation unit 202 configured to calculate a point of action of the external force based on the force data as acquired by the acquisition unit 201; and the configuration unit 203 configured to set the point of action of the external force as a tool tip point of the robot 1.

With the robot control device 2, it is possible to easily and intuitively set a tool tip point without having to operate the robot 1.

(2) In the robot control devices 2, 2a described in (1), the sensors 10, 10a may be six-axis force sensors or torque sensors.

Thereby, the robot control devices 2, 2a are able to achieve effects similar to those according to (1).

(3) In the robot control device 2b described in (1) or (2), the storage unit 22 configured to store the point of action calculated by the point-of-action calculation unit 202b may be further included, and the configuration unit 203b may set, when the storage unit 22 is storing two points of action, a midpoint on a straight line connecting the two points of action as a tool tip point.

Thereby, the robot control device 2b is able to set a tool tip point even when the user U is not able to directly apply a force to the tool 13 due to a suspended position, for example.

(4) In the robot control device 2b described in (3), the display unit 23 configured to display a screen indicating a positional relationship between a straight line connecting two points of action and the robot 1 and the input unit 21 configured to designate a desired position on the straight line displayed on the screen may be further included.

Thereby, the robot control device 2b is able to set an optimum position in accordance with the tool 13 attached to the robot 1 as a tool tip point.

(5) In the robot control device 2b described in (1) or (2), the storage unit 22 configured to store the point of action calculated by the point-of-action calculation unit 202b may be further included, and the configuration unit 203b may set, when the storage unit 22 is storing three or more points of action as a plurality of points of action, a midpoint in a polygonal shape formed by connecting the plurality of points of action as a tool tip point.

Thereby, the robot control device 2b is able to achieve effects similar to those according to (3).

(6) In the robot control device 2b described in (5), the display unit 23 configured to display a screen indicating a positional relationship between the polygonal shape formed by connecting the plurality of points of action and the robot 1 and the input unit 21 configured to designate a desired position in the polygonal shape displayed on the screen may be further included.

Thereby, the robot control device 2b is able to achieve effects similar to those according to (4).

(7) In the robot control devices 2, 2a described in (1) or (2), the display unit 23 and the input unit 21 may be included, the point-of-action calculation units 202, 202a may each calculate a straight line passing through a point of action of the external force, the display unit 23 may be caused to display a screen indicating a positional relationship between the straight line and each of the robots 1, 1a, the input unit 21 may designate a desired position on the straight line displayed on the screen, and the configuration unit 203 may set the designated desired position as a tool tip point of each of the robots 1, 1a.

Thereby, the robot control devices 2, 2a are able to achieve effects similar to those according to (4).

### EXPLANATION OF REFERENCE NUMERALS

1, 1a Robot

10, 10a Sensor

2, 2a, 2b Robot control device

20, 20a, 20b Control unit

201 Acquisition unit

202, 202a, 202b Point-of-action calculation unit

203, 203b Configuration unit

204 Display control unit

21 Input unit

22 Storage unit

23 Display unit

100, 100A, 100B Robot system

1. A robot control device comprising:
an acquisition unit configured to acquire force data indicating an external force applied to a tool attached to a robot as detected by a sensor disposed on the robot;
a point-of-action calculation unit configured to calculate a point of action of the external force based on the force data as acquired by the acquisition unit; and
a configuration unit configured to set the point of action of the external force as a tool tip point of the robot.

2. The robot control device according to claim 1, wherein the sensor is a six-axis force sensor or a torque sensor.

3. The robot control device according to claim 1,
further comprising a storage unit configured to store the point of action calculated by the point-of-action calculation unit,
wherein the configuration unit sets, when the storage unit is storing two points of action, a midpoint on a straight line connecting the two points of action as the tool tip point.

4. The robot control device according to claim 3, further comprising:
a display unit configured to display a screen indicating a positional relationship between the straight line connecting the two points of action and the robot; and
an input unit configured to designate a desired position on the straight line displayed on the screen.

5. The robot control device according to claim 1,
further comprising a storage unit configured to store the point of action calculated by the point-of-action calculation unit,
wherein the configuration unit sets, when the storage unit is storing three or more points of action as a plurality of points of action, a midpoint in a polygonal shape formed by connecting the plurality of points of action as the tool tip point.

6. The robot control device according to claim 5, further comprising:
a display unit configured to display a screen indicating a positional relationship between the polygonal shape formed by connecting the plurality of points of action and the robot; and
an input unit configured to designate a desired position in the polygonal shape displayed on the screen.

7. The robot control device according to claim 1,
further comprising:
a display unit; and
an input unit,
wherein
the point-of-action calculation unit calculates a straight line passing through a point of action of the external force,
the display unit displays a screen indicating a positional relationship between the straight line and the robot,
the input unit designates a desired position on the straight line displayed on the screen, and
the configuration unit sets the designated desired position as a tool tip point of the robot.
